(19) United States
(12) Patent Application Publication
(10) Pub. No.: US 2026/0091965 A1
(43) Pub. Date: Apr. 2, 2026

(54) AERIAL WORK VEHICLE

(71) Applicant: TADANO UTILITIES LTD., Nagano (JP)

(72) Inventors: Yasuhisa TSUKAMOTO, Nagano (JP); Eiji GOZU, Nagano (JP); Seiichi YUMOTO, Nagano (JP); Longjun JIN, Nagano (JP); Kenji ARAI, Nagano (JP)

(21) Appl. No.: 19/113,112

(22) PCT Filed: Jan. 10, 2024
(86) PCT No.: PCT/JP2024/000232

§ 371 Date: Mar. 19, 2025

(30) Foreign Application Priority Data
Jan. 18, 2023 (JP) 2023-005591
Nov. 22, 2023 (JP) 2023-198457

(51) Int. Cl. B66F 11/04; F15B 15/26

(52) U.S. Cl. CPC B66F 11/044; F15B 15/26

(57) ABSTRACT

It is an object to provide an aerial work vehicle in which an engine drive unit and an electric drive unit that serve as a power source can be interchanged depending on the usage environment, where the interchanging of power source is easy, and the vehicle is balanced so that the center of gravity position of the vehicle remains unchanged before and after the interchanging. As a solution, a first mounting portion (8), on which an engine drive unit (7) and an electric drive unit (13) that serve as a power source of a hydraulic device (11) are interchangeably mounted, and a second mounting portion (10), on which a counterweight (9) and a battery (14) which provide a balancing mass are interchangeably mounted, are arranged on different sides of a raising/lowering unit (5) on a vehicle body frame (3).

### TECHNICAL FIELD

The present disclosure relates to an aerial work vehicle in which the power source can be switched between an engine drive unit and an electric drive unit depending on the usage environment.

### BACKGROUND ART

Working vehicles, such as aerial work vehicles use an engine drive unit as a power source to drive a hydraulic pump and thereby run a travel unit equipped with crawlers, slew a vehicle frame, and/or raise and lower a boom.

However, for indoor work sites where exhaust gas emissions are not permitted, urban areas with noise regulations or for use at nighttime work sites, it is desirable to use working vehicles equipped with electric drive units instead of engine drive units.

However, there are also work sites without electrical power supplying equipment, or with high temperature environments where the outside temperature exceeds 40° C. and electrical components are prone to overheating and will need time to cool down, extending the job time. Conversely in low temperature environments where the outside temperature is 0° C. or below, battery power will drain quickly and running time is reduced. In such situations, working vehicles equipped with engine drive units instead of electric drive units are desirable.

While it would be possible to produce a working vehicle equipped with an engine drive unit and an electric drive unit as power sources and selectively use a drive unit according to the usage environment, such vehicle would be costly. While it would also be conceivably possible to convert a vehicle equipped with an engine drive unit or an electric drive unit to a hybrid drive configuration, this would result in high development and manufacturing costs.

Note that although not an aerial work vehicle, a ground support vehicle for airport use has been proposed which can be easily converted from an engine-driven vehicle to an electrically driven vehicle. In more detail, a first mounting portion and a second mounting portion are provided on the vehicle body frame, a battery frame, which is equipped with a battery, and an engine frame, which is equipped with an engine and a piston pump driven by the engine, are interchangeably provided on the first mounting portion, a fuel tank is attached to the second mounting portion when the engine frame has been attached to the first mounting portion, and an electric motor and a piston pump driven by the electric motor are attached to the second mounting portion when the battery frame has been attached to the first mounting portion (see Patent Document 1: Japanese Laid-open Patent Publication No. 2022-74939).

### Citation List

### Patent Documents

Patent Document 1: Japanese Laid-open Patent Publication No. 2022-74939

### SUMMARY OF INVENTION

### Technical Problem

However, with the configuration in Patent Document 1 cited above, since the position of the piston pump changes between the first mounting portion and the second mounting portion when changing between the engine frame and the battery frame, it is necessary to reconnect the hydraulic pipes, which increases the workload.

Also, since the engine as a power source and a piston pump driven by the engine, and the electric motor as a power source and a piston pump driven by the electric motor are interchanged as integrated units, this increases the weight of the equipment being interchanged, making the work more difficult. When interchanging frames, which are heavy objects, it is also necessary to balance the vehicle in keeping with its center of gravity.

In addition, for aerial work vehicles, a technology for converting between an engine-driven vehicle and an electrically driven vehicle is yet to be announced.

### Solution to Problem

The present disclosure is intended to solve the problems described above, and has an object of providing an aerial work vehicle in which an engine drive unit and an electric drive unit that serve as a power source can be interchanged depending on the usage environment, where the interchanging of power source is easy, and the vehicle is balanced so that the center of gravity position of the vehicle remains unchanged before and after the interchanging.

To achieve the stated object, an aerial work vehicle according to an aspect of the present disclosure has the following configuration. An aerial work vehicle holds a worker in a basket provided at a front end of a raising/lowering boom and is capable of travelling operations, raising/lowering operations, and slewing operations, the aerial work vehicle including: a vehicle body frame including a hydraulic unit that supplies hydraulic oil to each operated unit provided in the vehicle and a main counterweight that provides a stabilizing mass that acts against a tipping mass that acts upon the vehicle; and a raising/lowering unit that is mounted on the vehicle body frame, is supplied with hydraulic oil from the hydraulic unit, and raises and lowers the raising/lowering boom to move the basket supported at the front end of the boom to a desired height, wherein the vehicle body frame is provided with a first mounting portion, on which an engine drive unit and an electric drive unit which serve as a power source for the hydraulic unit are interchangeably mounted, and a second mounting portion, on which a counterweight and a battery which provide a balancing mass are interchangeably mounted.

According to the above configuration, by interchanging the engine drive unit and the electric drive unit that serve as the power source of the hydraulic unit at the first mounting portion on the vehicle body frame and interchanging the counterweight and the battery that provide a balancing weight at the second mounting portion, it is possible to use the same aerial work vehicle and switch between the engine drive unit and electric drive unit that serves as the power source in keeping with the usage environment, which reduces the vehicle cost.

Since the counterweight and the battery that have an equivalent balancing effect are interchanged at the second mounting portion, it is possible to balance the vehicle so that the center of gravity position is unchanged before and after the unit at the first mounting portion is interchanged.

By attaching the counterweight to the second mounting unit as necessary when the engine drive unit has been mounted on the first mounting portion and attaching the battery to the second mounting portion when the electric drive unit has been attached to the first mounting portion, the interchanging of power source is simplified, and the vehicle can remain balanced before and after the interchanging of power source.

The engine drive unit may include an engine, a radiator, and a fuel tank, and the electric drive unit may include an electric motor and a motor controller. By doing so, the weight of the drive units that are interchanged is reduced as much as possible, which makes the task of interchanging these units easier.

The hydraulic unit preferably includes a hydraulic pump, a control valve, a slewing motor, a raising/lowering cylinder, and a hydraulic oil tank, and is preferably provided for common use even when a power source of the hydraulic unit is interchanged on the vehicle body frame. By doing so, since shared use is made of the hydraulic unit even when the drive units are interchanged, there is no need to change the hydraulic pipes connected to the hydraulic pump when switching between power sources, which makes the interchanging of power source more efficient.

Locking portions may be provided on the hydraulic pump of the hydraulic unit, and a suspending unit that locks to the locking portions and suspends the hydraulic pump so as to be movable in a drive shaft direction and a height direction may be provided in a vicinity of the first mounting portion of the vehicle body frame.

By doing so, when switching between the engine drive unit and the electric drive unit, the hydraulic pump can be suspended by the suspending unit attached to the vehicle body frame and appropriately moved in the drive shaft direction (and as necessary in the height direction) without using a large-scale apparatus, such as a large crane. This makes it possible to interchange the power source in a narrow space with a reduced workload. Since hydraulic pipes are not detached during the replacement, the work has a reduced workload with no risk of environmental pollution due to the hydraulic oil leaking.

It is preferable for the hydraulic unit to be provided with a plurality of hydraulic pipes including a suction hose connected to a hydraulic pump and a discharge hose connected to a control valve, and for the plurality of hydraulic pipes to be connected with lengths including slack in a drive shaft direction and a height direction.

By doing so, when the engine drive unit and the electric drive unit are interchanged, since some slack is provided in the length of the hydraulic pipes even when the position of the hydraulic unit moves, there is no risk of the hydraulic pipes interfering with or coming off during the switching of the power source.

It is preferable for a platform on which either the engine drive unit or the electric drive unit is mounted to be detachably provided on the first mounting portion, and for the platform to be provided with arm insertion support portions into which lift arms of a forklift are inserted to enable the platform to be raised and lowered.

In this way, when switching between platforms on which the engine drive unit and the electric drive unit are mounted, the replacement can be performed simply by inserting the lift arms of a forklift into the arm insertion support portions and attaching and detaching a platform to and from the vehicle body frame, which reduces the workload required to switch between power sources.

It is preferable for the platform to be provided with a plurality of engagement holes into which a plurality of guide pins that protrude on the vehicle body frame are fitted, so that when the guide pins have been fitted into the engagement holes of the platform, an axial center position of the engine drive unit or the electric drive unit on the vehicle body frame is determined.

Since the axial center position of the engine drive unit or the electric drive unit can be determined simply by interchanging the platform on the vehicle body frame, the task of switching between power sources can be performed easily and quickly by simply adjusting the hydraulic unit into alignment with the axial center position.

### Advantageous Effects of Invention

An aerial work vehicle is provided where an engine drive unit and an electric drive unit that serve as a power source can be interchanged depending on the usage environment, the interchanging of power source is easy, and the vehicle is balanced so that the center of gravity position of the vehicle remains unchanged before and after the interchanging.

### BRIEF DESCRIPTION OF DRAWINGS

FIG. 1A is a side view of an aerial work vehicle,

FIG. 1B is a plan view, and

FIG. 1C is a right side view.

FIG. 2A is a front view depicting the configuration of a vehicle body frame equipped with an engine drive unit,

FIGS. 2B and 2C are left and right side views, and

FIG. 2D is a plan view.

FIG. 3A is a front view depicting the configuration of a vehicle body frame equipped with an engine drive unit,

FIGS. 3B and 3C are left and right side views, and

FIG. 3D is a plan view.

FIG. 4 is an overhead layout diagram depicting one example of interchanging of an engine drive unit and an electric drive unit on a vehicle body frame.

FIG. 5 is a diagram useful in explaining a hydraulic drive system in which the engine drive unit has been replaced with an electric drive unit.

FIGS. 6A to 6C are plan views depicting a replacement process for removing an engine drive unit from a vehicle body frame, and

FIGS. 6D and 6E are perspective views before and after attachment and detachment of the engine drive unit.

FIGS. 7A to 7C are plan views depicting a replacement process for attaching an electric drive unit to the body frame, and

FIG. 7D is a perspective view of the electric drive unit before mounting on the body frame.

FIGS. 8A and 8B are perspective views before and after operation of a suspending unit provided on the vehicle body frame.

### DESCRIPTION OF EMBODIMENTS

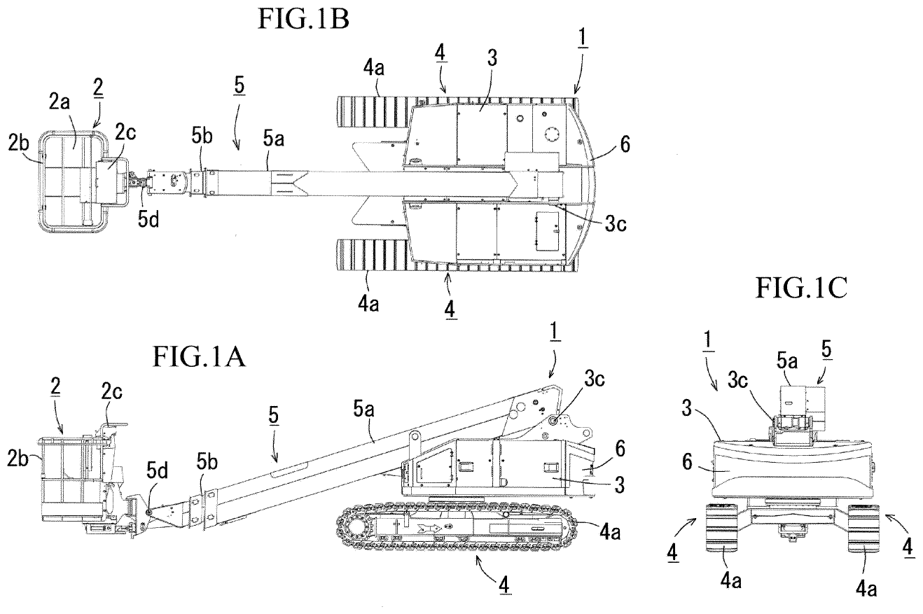

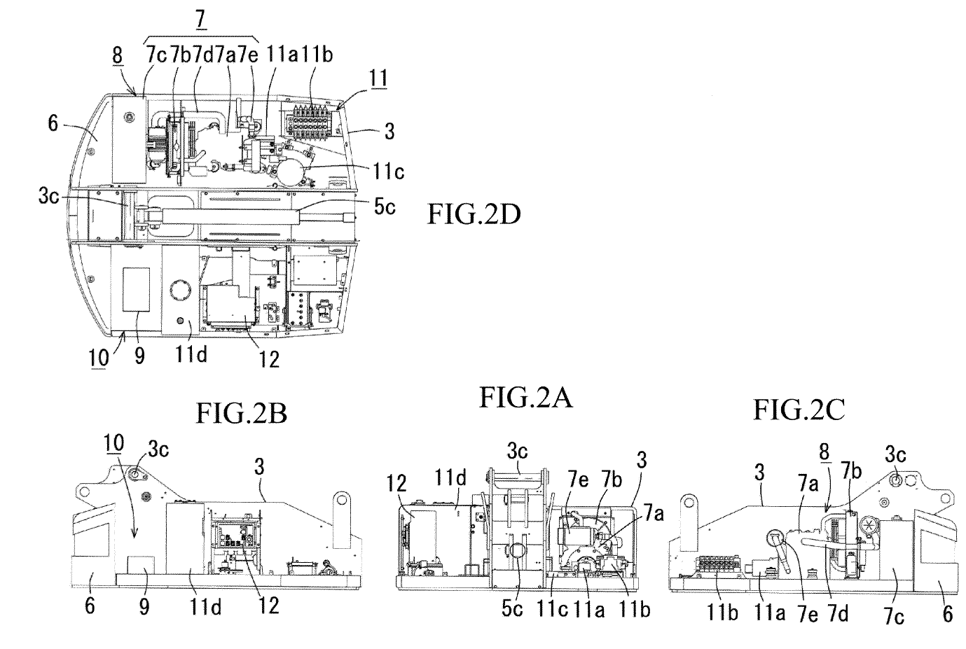

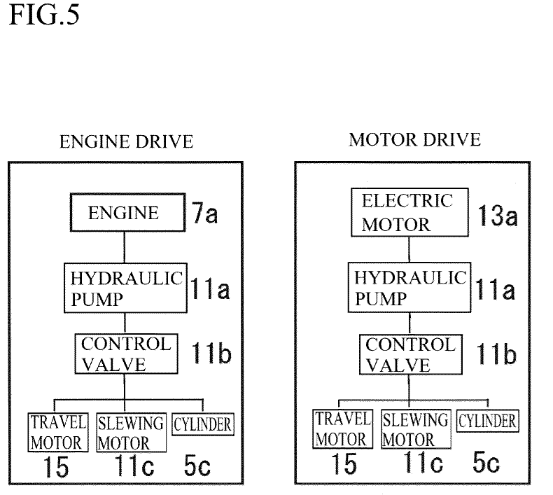

The overall configuration of an aerial work vehicle is described below with reference to FIGS. 1A to 1C. The aerial work vehicle 1 is a working vehicle capable of travelling, raising and lowering, and slewing operations while holding a worker in a basket 2 attached to the front end of a raising/lowering boom. The vehicle body frame 3 houses a hydraulic unit 11 (see FIG. 2D) which as described later includes a power source, a hydraulic pump 11a driven by the power source, and a control valve 11b. As depicted in FIGS. 1A and 1C, the vehicle body frame 3 is mounted on the travel unit 4 so as to be capable of slewing. The travel unit 4 is a pair of crawler units provided with crawlers 4a. Each crawler unit is supplied with hydraulic pressure from the hydraulic unit 11 housed in the vehicle body frame 3 and travels using a hydraulic travel motor 15 (see FIG. 5). Note that instead of the crawler units, the travel unit 4 may include four wheels.

A raising/lowering unit 5 is mounted on the vehicle body frame 3. The raising/lowering unit 5 is supplied with hydraulic pressure from the hydraulic unit 11 and raises and lowers a raising/lowering boom, which moves the basket 2 supported at the front end of the boom to a desired height. As one example, as depicted in FIG. 1A, the raising/lowering unit 5 includes a first boom 5a, which can be raised, and a second boom 5b, which can be extended and retracted relative to the first boom 5a, in a concentric arrangement. The first boom 5a is connected to a raising/lowering cylinder 5c (see FIG. 2D), with the first boom 5a being raised by rotating about a rotational shaft 3c. As depicted in FIGS. 1A and 1B, the basket 2 is connected to the front end of the second boom 5b via a link mechanism and a rotational shaft 5d. The basket 2 is configured to rotate about the rotational shaft 5d so as to maintain a horizontal posture even when the first boom 5a is raised and/or the second boom 5b extends or retracts relative to the first boom 5a. The worker in the basket 2 can raise and lower the basket 2 by operating the raising/lowering cylinder 5c so as to raise the first boom 5a by rotating about the rotational shaft 3c. The basket 2 can be further raised and lowered by operating an extending/retracting cylinder, not illustrated, to extend and retract the second boom 5b relative to the first boom 5a. By doing so, the operator can move the basket 2 to the desired height. Note that with a folding raising/lowering unit 5 where the first boom 5a and the second boom 5b are folded together via a connector portion, raising operations of the first boom 5a and raising operations of the second boom 5b may be performed by driving separate cylinders.

As depicted in FIG. 1B, the basket 2 includes a floor surface 2a that supports a worker and a guard frame 2b that surrounds the floor surface 2a. The basket 2 includes an operation unit 2c (operation switches, operation levers, an operation panel, a display unit, and the like) that sends commands to operated units of the work vehicle. The raising/lowering unit 5 is mounted on the vehicle body frame 3. Although the raising/lowering unit 5 is disposed at the center in the width direction (a direction that is perpendicular to the front-rear direction) of the vehicle body frame 3 in the present embodiment, the raising/lowering unit 5 may instead be disposed at a position that is off-center to either side. A main counterweight 6 is provided at the front end (that is, the opposite end to the basket 2) of the vehicle body frame 3. The main counterweight 6 provides a stabilizing mass against a tipping mass that acts on the vehicle due to the basket 2, the raising/lowering unit 5, and the like.

Next, the internal structure of the vehicle body frame 3 will be described with reference to FIGS. 2A to 5.

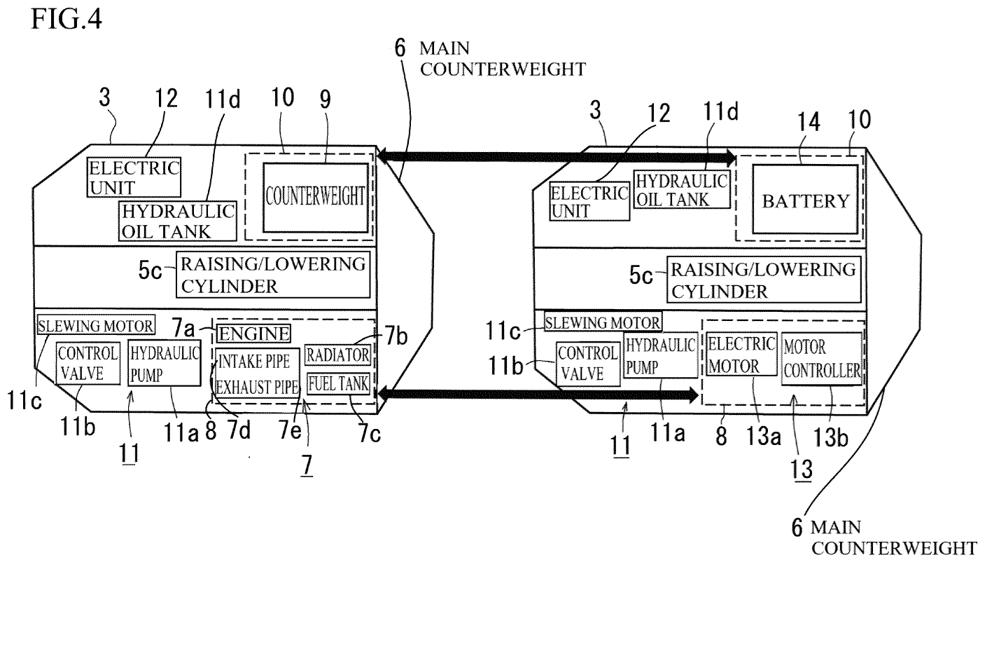

FIGS. 2A to 2D depict an example configuration of the vehicle body frame 3 that uses an engine drive unit 7 as a power source for the hydraulic unit 11. Note that the first boom 5a and the second boom 5b of the raising/lowering unit 5 mounted on the vehicle body frame 3 and the basket 2 have been omitted from FIGS. 2A to 2D. As depicted in FIG. 2D, on the vehicle body frame 3, a first mounting portion 8 (one area surrounded by a dashed line in FIG. 4) on which the engine drive unit 7 is disposed and a second mounting portion 10 (another area surrounded by a dashed line in FIG. 4) on which the counterweight 9 is disposed are arranged on different sides of the raising/lowering unit 5 (indicated in the drawing as the raising/lowering cylinder 5c). If the vehicle can still be balanced, the counterweight 9 may be omitted. The engine drive unit 7 includes an engine 7a, a radiator 7b, and a fuel tank 7c. The engine 7a is provided with an intake pipe 7d and an exhaust pipe 7e, which are connected to a combustion chamber, not illustrated.

As depicted in FIG. 2D, the vehicle body frame 3 is provided with the hydraulic unit 11 as a shared unit. The hydraulic unit 11 includes a hydraulic pump 11a that pressurizes hydraulic oil, a control valve 11b that sends the hydraulic oil to each part of the vehicle, a slewing motor 11c that slews the vehicle body frame 3, and a hydraulic oil tank 11d that stores the hydraulic oil. In addition to the hydraulic unit 11, an electric unit 12 is also included as a shared unit. The electric unit 12 includes electrical components, such as a power supply, operation control, and various switches for each operated unit provided in the vehicle, together with terminal blocks for wiring purposes.

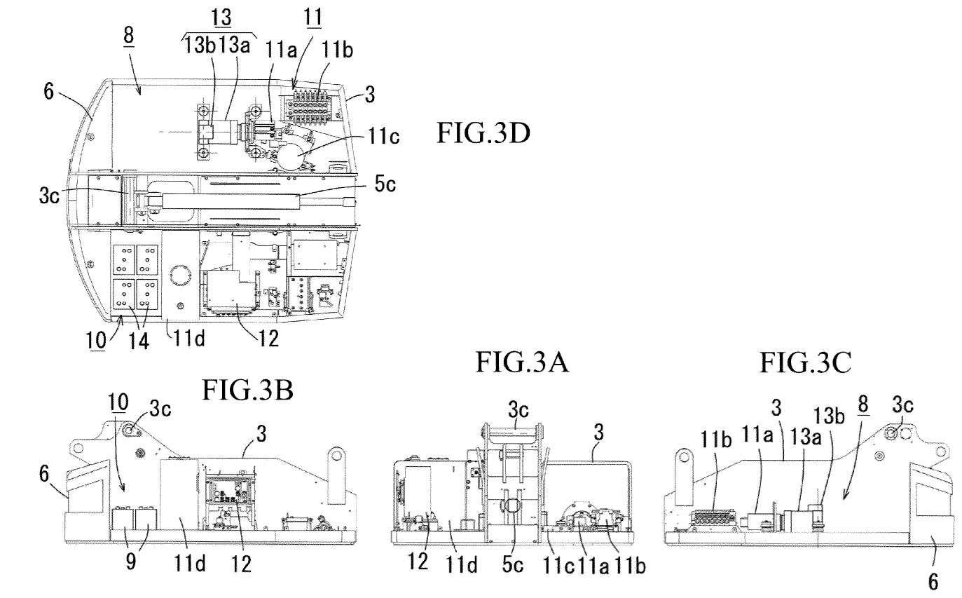

FIGS. 3A to 3D depict an example configuration of the vehicle body frame 3 that uses an electric drive unit 13 as a power source for the hydraulic unit 11. Note that the first boom 5a and the second boom 5b of the raising/lowering unit 5 mounted on the vehicle body frame 3 and the basket 2 have been omitted from FIGS. 3A to 3D. On the vehicle body frame 3, a first mounting portion 8 (one part surrounded by a dashed line in FIG. 4) where the electric drive unit 13 is disposed and the second mounting portion 10 (another part surrounded by a dashed line in FIG. 4) where a battery 14 is disposed are arranged on different sides of the raising/lowering unit 5 (indicated in the drawing as the raising/lowering cylinder 5c). The electric drive unit 13 includes an electric motor 13a, a motor controller 13b, and the like.

As depicted in FIG. 4, the electric drive unit 13 can be attached to the first mounting portion 8 of the vehicle body frame 3 in place of the engine drive unit 7. The electric drive unit 13 includes the electric motor 13a and the motor controller 13b. The battery 14 that acts as a balancing weight in place of the counterweight 9 can be attached to the second mounting portion 10. By reducing the weight of the engine drive unit 7 and the electric drive unit 13 that are interchanged as much as possible in this way makes the task of interchanging these units easier. Note that although the first mounting portion 8 and the second mounting portion 10 are arranged on different sides of the raising/lowering unit 5 (the raising/lowering cylinder 5c) on the vehicle body frame 3 in the present embodiment, the first mounting portion 8 and the second mounting portion 10 may both be disposed on one side of the raising/lowering unit 5.

In FIG. 4, when the engine drive unit 7 is attached to the first mounting portion 8, the counterweight 9 is attached to the second mounting portion 10, and when the electric drive unit 13 is attached to the first mounting portion 8, the battery 14 is attached to the second mounting portion 10. By doing so, the aerial work vehicle 1 equipped with an engine drive unit 7 in place of the electric drive unit 13 can be used in the usage environments described below. As examples, the engine drive unit 7 is favorably used at work sites without electrical power supplying equipment, in high temperature environments where the outside temperature exceeds 40° C. (and electric components are prone to overheating and will need time to cool down, which extending the job time), and in low temperature environments where the outside temperature is 0° C. or below (and battery power drains quickly and running time is reduced).

At indoor work sites where exhaust gas emissions are not permitted, in urban areas with noise regulations, or at nighttime work sites, the aerial work vehicle 1 can be used when equipped with the electric drive unit 13 in place of the engine drive unit 7.

In this way, by using the same aerial work vehicle 1 and switching between the engine drive unit 7 and the electric drive unit 13 that serves as the power source in keeping with the usage environment, it is possible to reduce the vehicle cost.

Since the counterweight 9 and the battery 14 that have an equivalent balancing effect are interchanged at the second mounting portion 10, it is possible to balance the vehicle so that the center of gravity position is unchanged before and after the unit at the first mounting portion 8 is interchanged. Since the hydraulic unit 11 provided on the vehicle body frame 3 is shared, there is no need to change the hydraulic pipes connected to the hydraulic pump 11a when switching between power sources, which makes the task of switching units more efficient.

FIG. 5 is a diagram useful in explaining a hydraulic drive system in the case where the engine drive unit 7 has been replaced with the electric drive unit 13. In the engine drive unit 7, the engine 7a that serves as a power source becomes the power source of the hydraulic pump 11a of the hydraulic unit 11. In the electric drive unit 13, the electric motor 13a that serves as a power source becomes the power source for the hydraulic pump 11a of the hydraulic unit 11. Hydraulic oil pumped under pressure from the hydraulic pump 13a is supplied to a hydraulic travel motor 15 via the control valve 11b to drive the travel unit 4. When hydraulic oil pressurized by the hydraulic pump 13a is supplied to the slewing motor 11c, the vehicle body frame 3 is caused to slew relative to the travel unit 4, when hydraulic oil is supplied to the raising/lowering cylinder 5c, this causes the first boom 5a to rise, and when hydraulic oil is supplied to the extending/retracting cylinder, not illustrated, this causes the second boom 5b to extend and retract relative to the first boom 5a, which moves the basket 2 to the desired height.

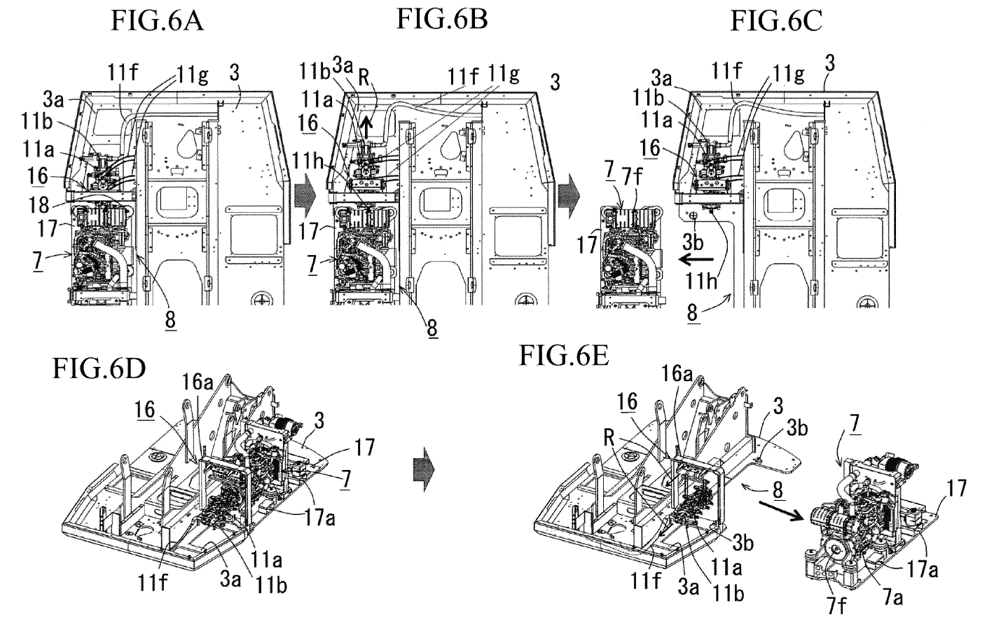

Here, one example of a detailed configuration and procedure for interchanging the engine drive unit 7 and the electric drive unit 13 will be described with reference to FIGS. 6A to 8B.

In FIG. 6A, a pair of locking portions 11e are provided on both sides in the axial direction of the hydraulic pump 11a of the hydraulic unit 11. This pair of locking portions 11e are inserted into locking holes 16il of lock rings 16i which, as described later, have been assembled on the hydraulic pump 11a.

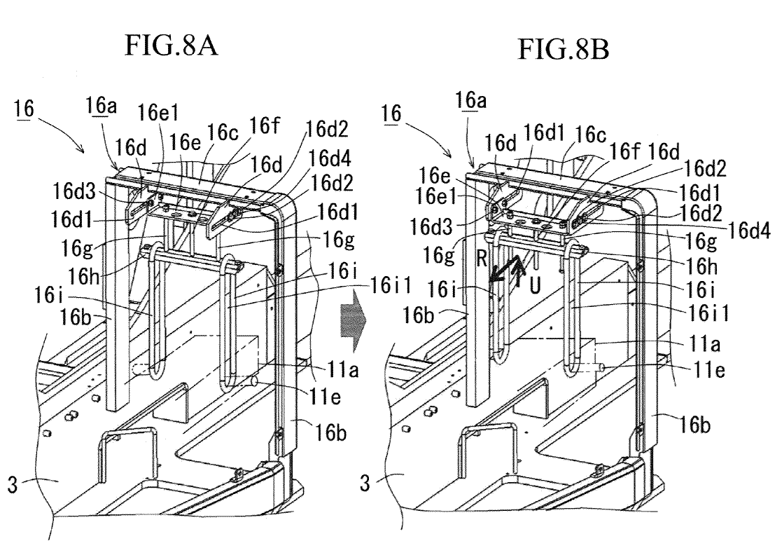

In FIG. 8A, a suspending unit 16 has a gate-shaped main body frame 16a whose leg frames 16b on both sides are fixed to the vehicle body frame 3. A pair of guide plates 16d are fixed to a top frame 16c. A slot 16d1 is formed in each of the pair of guide plates 16d along the drive shaft direction. A slide plate 16e is supported by the pair of guide plates 16d so as to be capable of moving along the drive shaft direction. The slide plate 16e is provided with two upright portions 16e1 on both sides in the length direction, including threaded holes in surfaces thereof that face the pair of guide plates 16d. These threaded holes are aligned with the slots 16d1 and two guide bolts 16d2 are inserted from outer side surfaces on the left and right and attached to nuts 16d3 from the inner side surfaces to secure the slide plate 16e. Fixing bolts 16d4 are screwed in between both pairs of guide bolts 16d2 to fix the sliding position of the slide plate 16e relative to the guide plates 16d. A suspended bolt 16f is provided so as to hang downward at the center in the length direction of the slide plate 16e with its bolt head engaged, and guide rods 16g are supported so as to hang downward on both sides of the suspended bolt 16f. The suspended bolt 16f is screwed into a support rod 16h. The guide rods 16g are slidably inserted into through holes in this support rod 16h. The lock rings 16i are supported on both sides in the length direction of the support rod 16h so as to hang downward. The lock rings 16i are track shaped and extend vertically, with the support rod 16h inserted into the upper ends of the slot-like center holes 16i1. The locking portions 11e of the hydraulic pump 11a mentioned above are inserted into the lower ends of these center holes 16i1. The power source (that is, the engine 7a or the electric motor 13a) connected to the hydraulic pump 11a is supported by anti-vibration rubber as described later, and may therefore move up, down, left, right, and to the front and rear. To absorb such movement of the power source, the locking portions 11e are inserted into the lower ends of the center holes 16il of the lock rings 16i with some clearance.

As depicted in FIG. 8B, when the suspended bolt 16f is rotated in a predetermined direction, the support rod 16h into which the suspended bolt 16f is threaded will rise, with the guide rods 16g guiding the support rod 16h as it rises. When this happens, the lock rings 16i that are supported so as to be suspended from the support rod 16h also rise in the direction of the arrow U. By doing so, the hydraulic pump 11a is further raised from a locking position via the locking portions 11e that have been inserted into the lower ends of the center holes 16i1. When the suspended bolt 16f is rotated in the opposite direction, the support rod 16h will fall, which causes the lock rings 16i to fall and lower the height position of the hydraulic pump 11a. Note that although the hydraulic pump 11a can be raised and lowered relative to the vehicle frame 3 by the suspending unit 16, the control valve 11b connected to the hydraulic pump 11a is supported on the vehicle body frame 3.

When the hydraulic pump 11a is removed from the engine drive unit 7 or the electric drive unit 13, it is necessary to retract the hydraulic pump 11a in the axial direction in order to release the connection between the drive shaft hole 7f or 13c of the engine 7a or the electric motor 13a and the drive shaft 11h of the hydraulic pump 11a (see FIG. 6C). To do so, the slide plate 16e is released from the state where the slide plate 16e is fixed to the guide plates 16d. In more detail, the fixing bolts 16d4 which are screwed in on both sides in the length direction are loosened, and the slide plate 16e is retracted in the direction of arrow R along the drive shaft direction. At this time, the slide plate 16e slides with the two guide bolts 16d2 on the left and right inserted in the slots 16d1. By doing so, the hydraulic pump 11a, which is connected via the pair of lock rings 11e, is retracted in the direction of arrow R.

With this configuration, when switching between the engine drive unit 7 and the electric drive unit 13, the hydraulic pump 11a can be suspended from the vehicle frame 3 by the suspending unit 16 attached to the vehicle body frame 3 and appropriately moved in the drive shaft direction and height direction without using a large-scale apparatus, such as a large crane. This makes it possible to engage and disengage the drive shaft hole of the power source and the drive shaft 11h of the hydraulic pump 11a in a narrow space with a reduced workload.

As depicted in FIG. 6B, the hydraulic unit 11 is provided with a plurality of hydraulic pipes including a suction hose 11f and a discharge hose 11g connected to the hydraulic pump 11a. This plurality of hydraulic pipes including the suction hose 11f and the discharge hose 11g are connected by lengths that include slack in the drive shaft direction and in the height direction. Excess space 3a is also provided near the end of the vehicle body frame 3 where the control valve 11b (see FIG. 2D) is disposed. This excess space 3a is used to route the discharge hose 11g, and serves as a buffer zone for the slack in the hose.

By doing so, when the engine drive unit 7 and the electric drive unit 13 are interchanged, since some slack in the length of the hydraulic pipes is expected when the position of the hydraulic pump 11a is retracted along the drive shaft direction as depicted by the arrow R in FIG. 6B, there is no risk of the hydraulic pipes interfering with or coming off during the switching of the power source. Even when the hydraulic pump 11a is retracted in the direction of the arrow R, the discharge hose 11g will bend within the excess space 3a and will not interfere with the switching of power source.

As depicted in FIG. 6E, the engine drive unit 7 or the electric drive unit 13 attached to the first mounting portion 8 is switched while mounted on a platform 17. The platform 17 is a base plate that serves as part of the vehicle body frame 3, and each power source is switched together with a platform 17 on the vehicle body frame 3. In the case of the engine drive unit 7, the engine 7a, the radiator 7b, and the fuel tank 7c are integrally mounted on a platform 17 as depicted in FIG. 2D. In the case of the electric drive unit 13, the electric motor 13a, the motor controller 13b, and the like are integrally mounted on a platform 17 as depicted in FIG. 3D. Note that anti-vibration material (as one example, anti-vibration rubber) is laminated on the support legs (not illustrated) that support the engine drive unit 7 at a plurality of locations (here, four locations) on the platform 17. A platform 17 is prone to vibration when driven by the engine 7a, but the engine drive unit 7 of the configuration given here can absorb vibrations and reduce noise. Note that the electric drive unit 13 is also supported on the platform 17 by support legs with an anti-vibration material.

As depicted in FIG. 6E, two arm insertion support portions 17a shaped as rectangular cylinders are provided on the upper surface of the platform 17. A pair of lift arms of a forklift, not illustrated, are inserted into these arm insertion support portions 17a, so that the engine drive unit 7 or the electric drive unit 13 can be transported by lifting up the platform 17. In this way, when switching between platforms 17 on which the engine drive unit 7 and the electric drive unit 13 are mounted, the replacement can be performed simply by inserting the lift arms of the forklift into the arm insertion support portions 17a and attaching and detaching a platform 17 to and from the first mounting portion 8 of the vehicle body frame 3, which reduces the workload required for the switch.

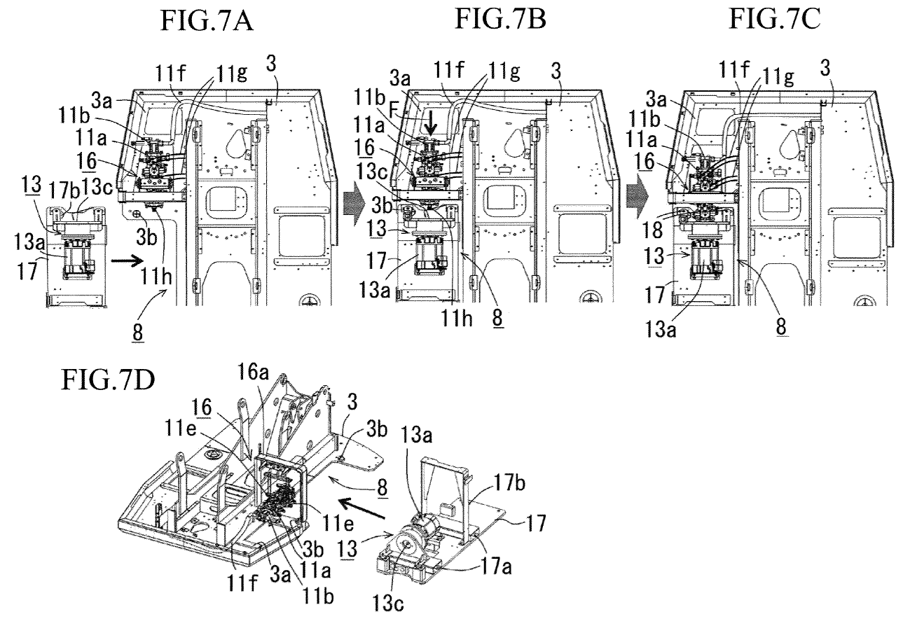

As depicted in FIG. 6E, a plurality of tapered guide pins 3b are provided at diagonally opposite positions on the vehicle body frame 3 on which the first mounting portion 8 is provided. The platform 17 is provided with a number of engagement holes 17b (see FIG. 7A) into which the guide pins 3b fit at positions corresponding to the engagement holes 17b. When the guide pins 3b are fitted into the engagement holes 17b of the platform 17, this determines the axial position of the drive shaft hole of the engine drive unit 7 or the electric drive unit 13 on the vehicle body frame 3 (see FIG. 7B). When a platform 17 is attached to the first mounting portion 8, the platform 17 is fixed by four attachment bolts 18 as depicted in FIG. 6A. Note that as one example, a splined shaft is used for the drive shaft 11h of the hydraulic pump 11a (see FIG. 6C), and shaft holes into which the splined shaft fits are provided as the drive shaft holes 7f, 13c of the engine 7a and the electric motor 13a (see FIG. 6E and FIG. 7D).

By doing so, since the axial position of the drive shaft hole 7f or 13c of the engine drive unit 7 or the electric drive unit 13 can be determined merely by replacing the platform 17 using a forklift, the power source can be switched easily and quickly by merely adjusting the axial position (and, as necessary, the height position) of the drive shaft 11h of the hydraulic pump 11a of the hydraulic unit 11 using the suspending unit 16. In particular, having the engine drive unit 7 or the electric drive unit 13 replaced together with a platform 17 at the first mounting portion 8 of the vehicle body frame 3 facilitates the task of switching the power source.

Next, an example of the procedure for replacing the engine drive unit 7 that was previously attached to the first mounting portion 8 of the vehicle body frame 3 with the electric drive unit 13 will be described with reference to FIGS. 6A to 6C and FIGS. 7A to 7C.

FIG. 6A is a partial plan view depicting a state where the engine drive unit 7 is mounted on the first mounting portion 8 of the vehicle body frame 3, and FIG. 6D is a perspective view of the same.

First, the hydraulic pump 11a is slightly suspended from the suspending unit 16 and is retracted along the drive shaft direction as indicated by the arrow R in FIG. 6B. In more detail, in the suspending unit 16 depicted in FIG. 8B, the fixing of the slide plate 16e to the guide plates 16d is released. The fixing bolts 16d4 are loosened, and the slide plate 16e is retracted along the drive shaft direction in the direction of the arrow R. By doing so, the drive shaft hole 7f of the engine drive unit 7 is removed from the drive shaft 11h of the hydraulic pump 11a, and the engagement between the drive shaft and the shaft hole is released. Note that although the discharge hose 11g connected to the control valve 11b also moves backward as the hydraulic pump 11a moves backward, this does not obstruct the work since the excess space 3a is utilized to absorb the bending of the hose.

Next, in FIG. 6C, the attachment bolts 18 that fix the platform 17 to the vehicle body frame 3 are removed, and a forklift, not illustrated, is used to insert the forklift arms into the arm insertion support portions 17a and lift the platform 17, which disengages the guide pins 3b and the engagement holes 17b (see FIG. 7A). Next, with the platform 17 supported by the forklift, the platform 17 is moved to a position that is withdrawn from the first mounting portion 8 of the vehicle body frame 3 and placed at this withdrawal position, as depicted in FIG. 6E.

After this, as depicted in FIGS. 7A and 7D, a platform 17 on which the electric drive unit 13 is mounted is lifted using a forklift, not illustrated, by inserting the lift arms into the arm insertion support portions 17a and transported to the first mounting portion 8 of the vehicle body frame 3 in the lifted state.

As depicted in FIG. 7B, the platform 17 is lowered toward the vehicle body frame 3 by the forklift, not illustrated, so that the engagement holes 17b (see FIG. 7A) engage the guide pins 3b. The attachment bolts 18 depicted in FIG. 7C are then screwed into the vehicle body frame 3 to fix the platform 17. By doing so, the axial position of the drive shaft hole 13c (see FIG. 7D) of the electric drive unit 13 on the vehicle body frame 3 is determined.

Next, after the forklift has withdrawn from the vehicle body frame 3, the hydraulic pump 11a suspended by the suspending unit 16 is moved forward along the drive shaft direction as indicated by the arrow F in FIG. 7B. In more detail, in the suspending unit 16 depicted in FIG. 8B, the fixing of the slide plate 16e to the guide plates 16d is released. The fixing bolts 16d4 are loosened, and the slide plate 16e is moved forward along the drive shaft direction in the direction of the arrow F in FIG. 7B. By doing so, as depicted in FIG. 7C, the drive shaft hole 13c of the electric drive unit 13 (see FIG. 7D) is fitted onto the drive shaft 11h of the hydraulic pump 11a, thereby engaging the drive shaft and the shaft hole. Note that although the discharge hose 11g connected to the control valve 11b also moves forward, since the bending of the hose, which was absorbed in the excess space 3a, is released, the work of switching between power sources is not obstructed.

Note that when the engine drive unit 7 and the electric drive unit 13 are interchanged, the controller that controls the power source is also interchanged.

As described above, when switching between the engine drive unit 7 and the electric drive unit 13, the hydraulic pump 11a can be suspended and supported by the suspending unit 16 attached to the vehicle body frame 3 and moved as appropriate in the drive shaft direction (and as necessary in the height direction) without using large-scale equipment such as a large crane. This enables the power source to be replaced in a narrow space with a reduced workload. Since the hydraulic pipes is designed to have slack in their lengths even when the position of the hydraulic pump 11a is moved, there is no risk of the hydraulic pipes interfering with or coming off during the switching of the power source.

Since a platform 17 on which either the engine drive unit 7 or the electric drive unit 13 is mounted is replaced, the power source can be interchanged by simply inserting the lift arms of a forklift into the arm insertion support portions 17a of a platform 17 and attaching and detaching an entire platform 17 to the vehicle body frame 3, which reduces the workload required to switch between power sources.

Since the axial center position of the drive shaft hole 7f or 13c of the engine drive unit 7 or the electric drive unit 13 can be determined simply by interchanging the platform 17 on the vehicle body frame 3, the task of switching between power sources can be performed easily and quickly by simply adjusting the drive shaft 11h of the hydraulic pump 11a into alignment with the shaft hole position using the suspending unit 16.

Although the aerial work vehicle 1 described above includes the raising/lowering unit 5 in which the first boom 5a and the second boom 5b are telescopic, the two booms may be connected in a foldable manner. The travel unit 4 may also be a wheeled type with four wheels instead of crawlers.

Although the platforms 17, on which the engine drive unit 7 or the electric drive unit 13 is mounted, have been described as being interchanged using a forklift, the platforms 17 may also be interchanged in a suspended state using a small crane, for example. In addition, in place of the lock rings 16i, the hydraulic pump 11a may be suspended by connecting the guide rods 16g and the locking portions 11e with ropes or the like whose lengths include some slack.

In addition, although a shaft hole provided on the power source side and the drive shaft 11h provided on the hydraulic pump 11a side are fitted together, it is also possible for a drive shaft provided on the power source side and a shaft hole provided on the hydraulic pump 11a side to be fitted together.

1. An aerial work vehicle that holds a worker in a basket provided at a front end of a raising/lowering boom and is capable of travelling operations, raising/lowering operations, and slewing operations, the aerial work vehicle comprising:
a vehicle body frame including a hydraulic unit that supplies hydraulic oil to each operated unit provided in the vehicle and a main counterweight that provides a stabilizing mass that acts against a tipping mass that acts upon the vehicle; and
a raising/lowering unit that is mounted on the vehicle body frame, is supplied with hydraulic oil from the hydraulic unit, and raises and lowers the raising/lowering boom to move the basket supported at the front end of the boom to a desired height,
wherein the vehicle body frame is provided with a first mounting portion, on which an engine drive unit and an electric drive unit which serve as a power source for the hydraulic unit are interchangeably mounted, and a second mounting portion, on which a counterweight and a battery which provide a balancing mass are interchangeably mounted.

2. The aerial work vehicle according to claim 1,
wherein the counterweight is attached to the second mounting unit as necessary when the engine drive unit has been mounted on the first mounting portion and the battery is attached to the second mounting portion when the electric drive unit has been attached to the first mounting portion.

3. The aerial work vehicle according to claim 1,
wherein the engine drive unit includes an engine, a radiator, and a fuel tank, and the electric drive unit includes an electric motor and a motor controller.

4. The aerial work vehicle according to claim 1,
wherein the hydraulic unit includes a hydraulic pump, a control valve, a slewing motor, a raising/lowering cylinder, and a hydraulic oil tank, and is provided for common use even when a power source of the hydraulic unit is interchanged on the vehicle body frame.

5. The aerial work vehicle according to claim 1,
wherein locking portions are provided on the hydraulic pump of the hydraulic unit, and a suspending unit that locks to the locking portions and suspends the hydraulic pump so as to be movable in a drive shaft direction and a height direction is provided in a vicinity of the first mounting portion of the vehicle body frame.

6. The aerial work vehicle according to claim 1,
wherein the hydraulic unit is provided with a plurality of hydraulic pipes including a suction hose connected to a hydraulic pump and a discharge hose connected to a control valve, and the plurality of hydraulic pipes are connected with lengths including slack in a drive shaft direction and a height direction.

7. The aerial work vehicle according to claim 1,
wherein a platform on which either the engine drive unit or the electric drive unit is mounted is detachably provided on the first mounting portion, and the platform is provided with arm insertion support portions into which lift arms of a forklift are inserted to enable the platform to be raised and lowered.

8. The aerial work vehicle according to claim 7,
wherein the platform is provided with a plurality of engagement holes into which a plurality of guide pins provided so as to protrude at diagonally opposite positions on the vehicle body frame are fitted, and when the guide pins have been fitted into the engagement holes of the platform, an axial center position of the engine drive unit or the electric drive unit on the vehicle body frame is determined.
